(19) United States
(12) Patent Application Publication
(10) Pub. No.: US 2005/0038138 A1
(43) Pub. Date: Feb. 17, 2005

(54) Chlorine-resistant elastan fibers

(75) Inventors: Stephan Hutte, Leverkusen (DE); Hans-Josef Behrens, Dormagen (DE); Hans-Peter Baldus, Leverkusen (DE); Holger Drews, Dormagen (DE)

Correspondence Address: NORRIS, MCLAUGHLIN & MARCUS, P.A., 875 THIRD AVE, 18TH FLOOR, NEW YORK, NY, 10022, US

(73) Assignee: Bayer Faser GmbH, Dormagen (DE)

(21) Appl. No.: 10/760,512

(22) Filed: Jan. 20, 2004

(30) Foreign Application Priority Data
Jan. 24, 2003 (DE) 10302912.5

(51) Int. Cl. C08K 9/10; C08K 9/00

(52) U.S. Cl. 523/210; 523/216

(57) ABSTRACT

Chlorine-resistant elastic polyurethane urea fibers containing hydrotalcites coated with metal fatty acid salts which are useful in aqueous, chlorine-containing environments, such as for swimming pool liners, and process for their production.

The present invention relates to elastic polyurethane urea fibers that can be used in aqueous, chlorine-containing environments, such as for example to line swimming pools. The invention also relates to elastic polyurethane urea fibers that contain coated hydrotalcites.

The expression “fiber” used within the context of the present invention includes staple fibers and/or continuous filaments, which can be produced by spinning processes known in principle, for example the dry spinning process or wet spinning process, as well as melt spinning

### BACKGROUND OF THE INVENTION

Elastic polyurethane urea fibers consisting of long-chain synthetic polymers that are composed in an amount of at least 85% of segmented polyurethane ureas based on for example polyethers, polyesters and/or polycarbonates, are well known. Yams made from such fibers are used to produce knitted fabrics or materials that in turn are suitable, inter alia, for corsetry, hosiery and sportswear, for example swimsuits and swimming trunks. In swimming pools the water is however often so strongly chlorinated for hygiene reasons that the active chlorine content is normally between 0.5 and 3 ppm (parts per million) or even higher. If polyurethane urea fibers are exposed to such an environment, it can lead to a degradation or deterioration of the physical properties, for example the strength of the fibers, and thereby to a premature wear of the textile material.

In practical terms, in the case of coarse-count fibers a certain degree of degradation of the fibers can be tolerated without the effects becoming noticeable to the user of the fabrics produced from such fibers. Nevertheless an improvement in the resistance of the fibers material to chlorine-induced degradation is necessary, in particular for yams with a high fineness (for example fibers with a count of less than 220 denier).

In order to improve the chlorine water resistance of elastic polyurethane urea yarns used for lining swimming pools, the polyurethane ureas have frequently been produced based on polyesters as low molecular weight monohydroxy-, dihydroxy- or polyhydroxy-functional polymers. Aliphatic polyesters however exhibit a high biological activity. For this reason the polyurethane ureas produced from this polymer have the disadvantage that they are readily degraded by microbes and fungi. It has also been shown that the chlorine water resistance of polyurethane ureas based on polyesters is not satisfactory.

A large number of additives in elastan fibers have been described in order to improve the chlorine water resistance of elastic polyurethane filaments.

The incorporation of zinc oxide into filaments of segmented polyurethane ureas for the purposes of chlorine stabilization is described in the specifications U.S. Pat. No. 5,028,642 and U.S. Pat. No. 6,406,788. Zinc oxide has the serious disadvantage however that it is washed out from the filament during the dyeing process of the fabrics, in particular under acid conditions (pH 3 to 4). The chlorine water resistance of the fibers is thus greatly reduced. Furthermore, due to the zinc-containing dye waste waters bacterial cultures in biologically operating clarification plants used to treat the waste waters are killed. As a result the operation of such clarification plants is seriously affected.

Published application JP 59-133 248 describes the incorporation of hydrotalcite in filaments consisting of segmented polyurethane ureas in order to improve the chlorine water resistance. Apart from the heavy metal-free stabilization, it is disclosed that only minor amounts of dispersed hydrotalcite are washed out under dyeing conditions in the acid range (pH 3 to 4) and accordingly a good chlorine water resistance is maintained. The disadvantage however is that hydrotalcite undergoes a high degree of agglomeration in polar solvents such as dimethylacetamide or dimethylformamide and even in spinning solutions for polyurethane urea fibers. Agglomerates in spinning solutions for polyurethane urea fibers rapidly cause blockage of the spinnerets during the spinning process, and for this reason the spinning process often has to be interrupted on account of frequent fiber breaks and/or increasing pressure in the spinnerets. It is therefore not possible to spin such polyurethane compositions over a prolonged time with sufficient operational reliability using this method. Furthermore, such filaments are not sufficiently resistant to chlorine-containing water.

In published application EP-A-558 758 a polyurethane urea composition is described that comprises a hydrotalcite containing water of crystallization and with adhering fatty acid. The disadvantage of this composition is that the chlorine water resistance of the described polyurethane urea fibers is not sufficient, the dyeability of the described polyurethane urea fibers in the processing with polyamide rigid fibers by acid dyes such as TELON® dyes (Bayer Aktiengesellschaft) is unsatisfactory, and a shade-to-shade coloration between mixed fabrics of for example polyurethane urea fibers and polyamide rigid fibers is not possible. Furthermore the adhering fatty acid sublimes together with the solvent from the fibers during the dry spinning process, resulting in contamination of the working environment and blockage of for example heat exchangers used to cool the solvent.

Published application JP 9 217 227 describes the incorporation of hydrotalcite, metal fatty acid salts and modified silicones into filaments for the production of polyurethane urea fibers. A disadvantage of this composition however is that the uncoated hydrotalcite agglomerates in polar solvents such as dimethylacetamide or dimethylformamide and even in spinning solutions for polyurethane urea fibers, as described above. Agglomerates in spinning solutions for polyurethane urea fibers can rapidly cause blockages in the spinnerets during the spinning process, as a result of which the spinning process often has to be interrupted on account of the frequent breakage of fibers and/or increasing pressure on the spinnerets. It is therefore also not possible to spin such polyurethane compositions over a prolonged time according to this method.

Patent application EP-A-843 029 describes a polyurethane urea composition and elastic polyurethane urea fibers specifically formed therefrom that contain hydrotalcites coated with polyorganosiloxane or a mixture of polyorganosiloxane and polyorganohydrogensiloxane and/or other basic metal-aluminium-hydroxy compounds. The disadvantage of this composition is that the chlorine water resistance of the described polyurethane urea fibers is still not sufficient. Furthermore, the continuous spinning of such polyurethane urea fibers over a prolonged period is likewise not possible, since after a few days' spinning the fibers begin to break when being wound onto the bobbin.

The object of the invention is to provide a polyurethane urea composition, in particular for polyurethane urea fibers (also termed elastan fibers), that has an improved or at least equivalent chlorine water resistance compared to the prior art, whose chlorine water stability is preferably achieved not by the addition of heavy metal-containing additives, and whose stabilizer does not adversely affect the spinning process per se or the physical properties of the polyurethane fibers.

### SUMMARY OF THE INVENTION

This object is achieved according to the invention by adding an effective amount of finely divided hydrotalcites coated with metal fatty acid salt to the polyurethane urea fibers.

### DETAILED DESCRIPTION

The invention accordingly provides polyurethane urea fibers (elastan fibers) with increased chlorine resistance comprising at least 85% of segmented polyurethane urea, wherein the polyurethane urea fibers contain 0.05 to 10 wt. % of finely divided hydrotalcite, in particular hydrotalcite of the general formula (1)
M₁₋ₓ²⁺Alₓ(OH)₂A′ₓ/nⁿ⁻.mH₂O (1),
wherein
M²⁺ denotes magnesium,
Aⁿ⁻ denotes an anion having the valency n from the list comprising OH⁻, F⁻, Cl⁻, Br⁻, CO₃²⁻, SO₄²⁻, HPO₄²⁻, silicate, acetate or oxalate, in particular OH⁻, F⁻, Cl⁻, Br⁻, Silicate, acetate or oxalate,
0<x≦0.5 and
0≦m<1
or hydrotalcite of the formula (2)
   Mg_{1-y}Al_{y}(OH)ᵤ(A²⁻)_{y/2}.wH₂O (2)
   wherein 0.20<y<0.35, u is a number from 1 to 10, w is a number from 0 to 20 and A²⁻ is an anion from the list CO₃²⁻, SO₄²⁻ or HPO₄²⁻, in particular CO₃²⁻,
   characterized in that the hydrotalcites are coated with 0.2 to 15 wt. % of a metal fatty acid salt.

The amount of the hydrotalcite coated with metal fatty acid salt that is contained in finely divided form in the polyurethane urea fibers is 0.05 wt. % to 10 wt. %, preferably 0.5 wt. % to 8 wt. %, particularly preferably 1.5 wt. % to 7 wt. % and most particularly preferably 2 wt. % to 5 wt. %, referred to the weight of the polyurethane urea fibers. In the elastan fibers the hydrotalcite content may be distributed within the elastan fibers and/or on the fiber surface.

The hydrotalcites are in particular preferably those that are represented for example in the formulae (3) and (4):
Mg₆Al₂(OH)₁₆(A²⁻).wH₂O (3);
Mg₄Al₂(OH)₁₂(A²⁻).wH₂O (4)
in which A²⁻ and w have the meanings given above in formula (2).

Particularly preferred examples of hydrotalcites are those of the formulae (5) and (6):
Mg₆Al₂(OH)₁₆CO₃.5H₂O (5);
Mg₄Al₂(OH)₁₂CO₃.4H₂O (6).

The described metal salts of fatty acids are used to coat the hydrotalcites in an amount of preferably 0.2 to 15 wt. % referred to the weight of the hydrotalcite. Hydrotalcites that are coated with from 0.3 to 12 wt. % of fatty acid metal salt are particularly preferably used. Hydrotalcites that are coated with 0.5 to 8 wt. % of fatty acid metal salt are most particularly preferably used.

The metal salts of fatty acids that are used are those in which the metal is selected from main groups I to III of the Periodic System, or zinc. The fatty acids may be saturated or unsaturated, may contain at least 6 up to at most 30 carbon atoms, and may be monofunctional or bifunctional. The metal salts of fatty acids are particularly preferably lithium, magnesium, calcium, aluminum and zinc salts of oleic, palmitic or stearic acid, particularly preferably magnesium stearate, calcium stearate or aluminum stearate, and most particularly preferably magnesium stearate.

The process of coating the hydrotalcites may be carried out by spraying and/or mixing in the metal fatty acid salt jointly or separately in an arbitrary order preferably before and/or during a final grinding of the hydrotalcite. In this connection it is irrelevant whether the metal fatty acid salt is added during the production of the hydrotalcites to existing moist filter cakes, pastes or slurries before the drying, or whether it is added in a suitable way, for example by spraying, to the dry material immediately before the final grinding or, in the case of a steam-jet drying, it is added to the steam immediately before being fed into the jet mill. The metal fatty acid salt may optionally be converted into an emulsion before the addition.

The production of the hydrotalcites per se is carried out for example according to methods known in principle. Such methods are described for example in published applications EP 129 805-A1 or EP 117 289-A1.

The hydrotalcites coated with metal fatty acid salt are preferably produced from their starting compounds, for example from MgCO₃, Al₂O₃ and water in the presence of metal fatty acid salt and a solvent, such as for example water, a C₁-C₈-alcohol or of chlorinated hydrocarbons, following by drying, for example spray drying, in turn and optionally followed by grinding, for example in a bead mill. As regards the use of the hydrotalcites coated with metal fatty acid salt as fiber additive, there are preferably employed coated hydrotalcites with a mean diameter (numerical mean) of at most 5 μm, particularly preferably those with a mean diameter of at most 3 μm, most particularly preferably those with a mean diameter of at most 2 μm, and especially preferably those with a mean diameter of at most 1 μm.

The hydrotalcites coated with metal fatty acid salt may be added to the polyurethane urea composition at any convenient point in the production of polyurethane urea fibers. For example, the hydrotalcites coated with metal fatty acid salt may be added in the form of a solution or slurry to a solution or dispersion of other fiber additives and then mixed with the polymer solution upstream in relation to the fiber spinnerets or sprayed into the polymer solution. The hydrotalcites coated with metal fatty acid salt may of course also be added separately as dry powder or as a slurry in a suitable medium, to the polymer spinning solution. The hydrotalcites coated with metal fatty acid salt may in principle optionally also be used as a mixture with uncoated hydrotalcites or with hydrotalcites coated with known coating agents (for example fatty acids or polyorganosiloxane or a mixture of polyorganosiloxane and polyorganohydrogensiloxane) for the production of polyurethane urea fibers corresponding to the procedure described above if the aforedescribed disadvantages of the known coated hydrotalcites can be tolerated in the mixture.

The polyurethane urea fibers according to the invention may contain a plurality of further various additives for various purposes, for example matting agents, fillers, antioxidants, dyes, coloring agents and stabilizers against heat, light, UV radiation and vapors.

Examples of antioxidants and stabilizers against heat, light or UV radiation are stabilizers from the group comprising sterically hindered phenols, HALS stabilizers (hindered amine light stabilizer), triazines, benzophenones and benzotriazoles. Examples of pigments and matting agents include titanium dioxide, zinc oxide and barium sulfate. Examples of dyes are acid dyes, disperse dyes and pigment dyes, and optical brighteners. The aforementioned stabilizers may also be used in the form of mixtures and may contain an organic or inorganic coating agent. The said additives should preferably be used in such amounts that they do not have any adverse effects on the hydrotalcites coated with metal fatty acid salts.

Depending on the circumstances hydrotalcites agglomerate, as described, in the introduction in polar solvents such as for example dimethylacetamide, dimethylformamide or dimethylsulfoxide, that are conventionally used in dry or wet spinning processes for the production of polyurethane urea fibers. For this reason difficulties due to blockages of the spinnerets may arise during the spinning process in the case of spinning solutions with incorporated hydrotalcites, resulting in a sharp rise in the spineret pressure and/or breakage of the freshly formed fibers before or during the winding on a bobbin. If hydrotalcites coated with metal fatty acid salt are incorporated into polyurethane urea spinning solutions corresponding to the invention, then no agglomeration takes place in the spinneret and the mean grain size of the hydrotalcites coated with metal fatty acid salt remains unchanged. This improves the service life of the spinnerets and consequently the operational reliability and economy of the dry or wet spinning process of the polyurethane urea fibers according to the invention.

Consequently, as shown hereinafter in Example 1, the resistance of the resultant filaments to degradation induced by chlorine-containing water is also improved compared to fibers that are obtained from agglomerate-containing spinning solutions or polymer melts.

The invention also provides a process for the production of polyurethane urea fibers in which a long-chain synthetic polymer containing at least 85% segmented polyurethane is dissolved in an organic solvent, for example dimethylacetamide, dimethylformamide or dimethylsulfoxide, in an amount of 20 to 50 wt. % with reference to the polyurethane urea composition, preferably in an amount of 25 to 45 wt. % with reference to the polyurethane urea composition, and this solution is then spun through spinnerets according to the dry or wet spinning process into filaments, characterized in that hydrotalcite coated with a metal fatty acid salt is added in an amount of 0.05 wt. % to 10 wt. %, preferably in an amount of 0.5 wt. % to 8 wt. %, particularly preferably in an amount of 1.5 wt. % to 7 wt. % and most particularly preferably in an amount of 2 wt. % to 5 wt. % referred to the weight of the polyurethane urea fiber, to the spinning solution and is distributed within the filaments and/or on the filament surface.

If less than 0.05 wt. % of the hydrotalcites coated with metal fatty acid salt is distributed within the filament or on the filament surface, the effectiveness against the degradation of the polymer due to chlorine is in certain circumstances less satisfactory. The dispersion of substantially more than 10 wt. % of the hydrotalcites coated with metal fatty acid salt within the filament or on the filament surface may lead to disadvantageous physical properties of the fibers and is therefore less recommended.

The improved polyurethane urea fibers according to the invention comprise segmented polyurethanes, for example those that are based on polyethers, polyesters, polyether esters, polycarbonates and the like. Such fibers may be produced by methods that are known in principle, such as for example according to those methods that are described in the following patents: U.S. Pat. No. 2,929,804, U.S. Pat. No. 3,097,192, U.S. Pat. No. 3,428,711, U.S. Pat. No. 3,553,290 or U.S. Pat. No. 3,555,115. In addition the polyurethane urea fibers may be comprised of thermoplastic polyurethanes whose production is described for example in EP 679 738.

The segmented polyurethanes are in principle produced in particular from a linear homopolymer or copolymer with a hydroxy group at the end of the molecule and a molecular weight of 600 to 4000, for example from the group comprising polyester diols, polyether diols, polyesteramido diols, polycarbonate diols, polyacryl diols, polythioester diols, polythioether diols, polyhydrocarbon diols or a mixture or copolymers of compounds of this group. Furthermore the segmented polyurethane is based in particular on organic diisocyanates and chain extenders containing several active hydrogen atoms, such as for example diols and polyols, diamines and polyamines, hydroxylamines, hydrazines, polyhydrazides, polysemicarbazides, water or a mixture of these components.

Some of these polymers are more sensitive than others to degradation induced by chlorine. This is evident for example by comparing the results in the following Example 1. Accordingly, polyurethane urea fibers consisting of a polyurethane urea based on polyether are substantially more sensitive than polyurethane urea fibers consisting of a polyurethane urea based on polyester. For this reason the improvements achieved by the present invention are especially beneficial with respect to polyurethane urea fibers that comprise polyurethane ureas based on polyether.

The hydrotalcites coated with metal fatty acid salt constitute additives that do not contain any heavy metal and are harmless from the toxicological aspect, and are therefore preferred. In this way it may be ensured that, in the further processing of the polyurethane urea fibers, such as for example dyeing, no waste waters are formed that impair or destroy the function of a biologically operating clarification plant.

The service life of spinnerets and the duration of the continuous spinning process is a decisive fact with regard to the operational reliability and economy of dry and wet spinning processes. As is demonstrated in Example 2, by incorporating the hydrotalcites coated with metal fatty acid salt into polyurethane urea spinning solutions corresponding to the invention, the service life of the spinnerets and consequently the operational reliability and economy of the dry or wet spinning processes are improved.

Furthermore, as is shown in Example 3, the addition of antiblocking agents, for example magnesium stearate, in order to adjust the adhesion value as a measure of the adherence of the filaments to the bobbin can be reduced when using hydrotalcites coated with metal fatty acid salts. By reducing the amount of antiblocking agent added to the spinning solution blockage of spinnerets can be reduced and the operational reliability and economy of the dry and wet spinning processes can be improved.

The invention furthermore provides textile goods, in particular knitwear, hosiery or wovens, produced using the polyurethane urea fibers according to the invention, preferably mixed with synthetic hard fibers such as polyamide, polyester or polyacrylic fibers and/or natural fibers such as wool, silk or cotton.

The test methods described hereinafter are used to measure the various parameters that are required for the evaluation of the advantages of the present invention.

In order to determine the maximum tensile force extension and the fineness strength a simple tensile test is performed on elastan filament yam under temperature controlled conditions. The test method is carried out in accordance with DIN 53834 Part 1. The prepared test specimen is wound in the form of a loop around the hook of the measuring head and around a 10 mm loop clamp with a pretensioning force of 0.001 cN/dtex. The clamping length is 200 mm. A small lug formed from aluminum foil is suspended exactly at the height of the light barrier. The carriage travels at a deformation speed of 400% per minute (800 mm draw-off length) until the thread breaks, and returns to its original position after the measurement. 20 measurements are made per test specimen.

In order to test the resistance of the elastan fibers to chlorine-induced degradation, a 60 cm long yarn sample (for example four-filament yarn, total count 40 denier) that has been produced from the fibers is subjected to a “chlorine water fastness test” in accordance with DIN 54019. In this test a 60 cm-long length of yarn is secured free of tension on special specimen holders. Before the actual “chlorine water fastness test” a blank coloration is carried out at pH 4.5 (acetate buffer) at 98° C. for 1 hour. The specimen is then treated five times and ten times at room temperature, each time for 1 hour in the dark in the test solution consisting of a buffer solution (51.0 ml of 1.0 N NaOH, 18.6 g KCl and 15.5 g boric acid are dissolved in distilled water and made up to 1000 ml) and chlorine water with a chlorine content of 20 mg/l at pH 8.5. After each treatment the specimen is washed with distilled water and dried in air. After completion of the fifth treatment and tenth treatment, the physical properties of the specimen are measured as described in the preceding paragraphs. The behavior of the yams in this “chlorine bath water test” corresponds to the behavior of corresponding yearns in swimwear fabrics that are exposed to the chlorine present in swimming pools.

The chlorine concentration in the “chlorinated” water is defined here as that chlorine concentration that is able to oxidize iodide ions to iodine. This concentration is measured by a potassium iodide/sodium thiosulfate titration and is given as ppm “active chlorine” (Cl₂) per liter of test solution. The titration is carried out by adding 1 g of potassium iodide, 2 ml of phosphoric acid (85%) and 1 ml of a 10% starch solution to 100 ml of chlorinated water that is to be analyzed, and the mixture is titrated with 0.1 N sodium thiosulfate solution to a starch/iodine end point.

The adherence of the thread to a bobbin is determined by first of all cutting off the thread from the bobbin weighing 500 g up to 3 mm above the bobbin sleeve. A weight is then suspended on the thread and the weight which causes the thread to roll off the bobbin is determined. The adherence determined in this way is a measure of the processability of the bobbins. If the adherence is too high, then the processability into two-dimensional textile goods may be compromised on account of thread breakages. If on the other hand the adherence is too low the thread may become too loose on the bobbin in the coiling process on the dry spinning shaft or in the further processing into textile fabrics, may be pulled off, and may therefore no longer be able to be processed further.

The invention is described in more detail hereinafter by examples, without however being restricted thereto, and in which all percentage figures refer to the total weight of the fibers unless specified otherwise.

### EXAMPLES

In Examples 1 to 3 polyurethane urea fibers were produced from a polyether diol consisting of polytetrahydrofuran (PTHF) with an average molecular weight (number average) of 2000 g/mole. The diol was capped with methylene-bis(4-phenyldiisocyanate) (MDI) in a molar ratio of 1 to 1.65 and then underwent chain extension with a mixture of ethylenediamine (EDA) and diethylamine (DEA) in dimethylacetamide.

Following this a stock batch of additives was mixed with the polymers. This stock batch consisted of 55.3 wt. % of dimethylacetamide (DMAC), 11.1 wt. % of CYANOX® 1790 antioxidant ((1,3,5-tris(4-tert.-butyl-3-hydroxy-2,5-dimethyl-benzyl)-1,3,5-triazine-2,4,6-(1H,3H,5H)-trione, from Cytec Industries, Inc.), 7.6 wt. % of Aerosol OT 100 surfactant (from Cytec), 26.0 wt. % of a 30% spinning solution, and 0.001 wt. % of the dye Makrolexviolett (Bayer AG). This stock batch was added to the spinning solution in such an amount that the content of CYANOX® 1790 in the finished fibers was 1 wt. % referred to the solids content of the fiber polymer.

A second stock batch consisting of 30.9 wt. % of titanium dioxide RKB 3 type (Kerr-McGee Pigments GmbH & Co. KG), 44.5 wt. % of DMAC and 24.6 wt. % of a 22% spinning solution was added to this spinning solution in such an amount that the titanium dioxide content in the finished fibers was 0.05 wt. % referred to the polyurethane urea polymer.

A third stock batch consisting of 13.8 wt. % of the hydrotalcites specified in Table 1, 55.2 wt. % of dimethylacetamide and 31.0 wt. % of a 30% spinning solution was added to this spinning solution in such an amount that the content of hydrotalcites specified in Table 1 in the finished elastan fibers was 3.0 wt. % referred to the polyurethane urea polymer.

A further stock batch was now added to this spinning solution. This further batch consisted of 5.3 wt. % of magnesium stearate, 5.3 wt. % of SILWET® L 7607 silicone fluid (Crompton Specialities GmbH), 49.6 wt. % of dimethylacetamide and 39.8 wt. % of a 30% spinning solution, and was added in such an amount that the magnesium stearate content was 0.3 wt. % referred to the polyurethane urea polymer.

The production of a polyurethane urea solution based on a polyester diol was carried out according to the following procedure:
a polyester diol with a molecular weight (number average) of 2000 g/mole, consisting of adipic acid, hexanediol and neopentyl glycol, was capped with methylene-bis(4-phenyl diisocyanate) (MDI Bayer AG) and then underwent chain extension with a mixture of ethylenediamine (EDA) and diethylamine (DEA).

In order to produce the polyurethane urea composition 50 wt. % of polyester diol with a molecular weight (number average) of 2000 g/mole was mixed with 1 wt. % of 4-methyl-4-azaheptanediol-2,6 and 36.2 wt. % of dimethylacetamide (DMAC) and 12.8 wt. % of MDI at 25° C., heated to 50° C. and maintained at this temperature for 110 minutes, in order to obtain an isocyanate-capped polymer with an NCO content of 2.65% NCO.

After cooling the polymer to a temperature of 25° C. 100 parts by weight of the capped polymer were rapidly mixed with a solution of 1.32 parts by weight of EDA and 0.04 parts by weight of DEA in 187 parts of DMAC so as to form a polyurethane urea composition in DMAC with a solids content of 22%. By adding hexamethylene diisocyanate (HDI, Bayer AG) the molecular weight of the polymer was adjusted so as to produce a viscosity of 70 Pa·s (25° C.).

After the production of the polymers described in the preceding paragraph, a stock batch of additives was mixed with the latter. This stock batch consisted of 65.6 wt. % of DMAC, 11.5 wt. % of CYANOX® 1790 ((1,3,5-tris(4-tert.-butyl-3-hydroxy-2,5-dimethyl-benzyl)-1,3,5-triazine-2,4,6-(1H,3H,5H)-trione, (from Cytec), 5.7 wt. % of TINUVIN® 622 ultraviolet light stabilizer (polymer with a molecular weight of ca 3500 g/mole, consisting of succinic acid and 4-hydroxy-2,2,6,6-tetramethyl-1-piperidine ethanol, Ciba Geigy) and 17.2 wt. % of a 22% spinning solution and 0.001 wt. % of the dye Makrolexviolett B (Bayer AG). This stock batch was added to the spinning solution in such an amount that the Cyanox 1790 content was 1.0 wt. % referred to the total solids content in the polyurethane urea composition.

This spinning solution was mixed with a second stock batch consisting of 31 wt. % of titanium dioxide (TRONOX® TiO₂ R-KB-3, Kerr-McGee Pigments GmbH & Co. KG), 44.5 wt. % of dimethylacetamide and 24.5 wt. % of a 22% spinning solution in such an amount that the titanium dioxide content in the finished thread was 0.05 wt. % referred to the finished polyurethane urea fibers.

This spinning solution was now mixed with a further stock batch. This stock batch consisted of 5.3 wt. % of magnesium stearate, 5.3 wt. % of SELWET® L 7607 (Crompton Specialities GmbH), 49.6 wt. % of dimethylacetamide and 39.8 wt. % of a 30% spinning solution, and was added in such an amount as to produce a magnesium stearate content of 0.45 wt. % referred to the polyurethane urea polymer.

The finished spinning solutions were dry spun through spinnerets in a typical spinning machine into filaments with a count of 15 dtex, in each case three individual filaments being combined to form coalescing filament yams with a total count of 44 dtex. The fiber preparation consisting of polydimethylsiloxane with a viscosity of 3 cSt/25° C. was applied via a preparation roller, ca. 4.0 wt. % referred to the weight of the fiber being applied. The fiber was then wound at a rate of 900 m/min.

### EXAMPLE 1

The test results of the measurements to determine the resistance of elastan fibers to degradation induced by chlorine water are shown in Table 1. In this connection 5 polyurethane ureas based on polyethers and polyesters, as well as various stabilizers and accelerators, were used. It is found that the highest percentage proportion of the original maximum tensile force remains in particular in the samples 1-7 according to the invention. The stability to degradation induced by chlorine water is thus, as desired, very good in these samples.

### EXAMPLE 2

In order to evaluate the service life of spinnerets and the duration of the continuous spinning process, uncoated and coated hydrotalcites listed in Table 2 were added to polyurethane urea compositions based on polyether and processed into a polyurethane urea fiber by a dry spinning process as described hereinbefore. By incorporating the hydrotalcites coated with metal fatty acid salt into polyurethane urea spinning solutions, the service life of the spinnerets and consequently the operational reliability and economy of dry or wet spinning processes can be improved, as is shown in Example 2.

### EXAMPLE 3

In order to evaluate the thread data and in this connection in particular the adherence of polyurethane urea fibers, the coated hydrotalcites mentioned in Table 3 were added to polyurethane urea compositions based on polyether and spun as 44 dtex f3. The thread data were determined according to the previously described test protocols. As is shown in Table 3, the adherence largely depends on the substance used to coat the hydrotalcite. For example, an adherence of 0.20 to 0.25 cN is required for the successful processing of elastan fibers in circular knitting. In order to adjust this value the elastan fiber, which contains an hydrotalcite coated with polyorganosiloxane, must contain an additional amount of antiblocking agent, for example magnesium stearate. However, increasing the amount of antiblocking agent in the spinning solution can lead to a fairly rapid blockage of the spinnerets and adversely affect the operational reliability and economy of the dry and wet spinning processes.

TABLE 1

| | | Added | | | | Maximum | | Percentage |
|---|---|---|---|---|---|---|---|---|
| | | Amount of | Coating with | Concentration | Action | Tensile Force | Maximum | Proportion of the |
| | | Stabilizer | (wt. % referred | of Chlorine | Duration | Extension | Tensile | original Maximum |
| Sample | Stabilizer | (%) | to stabilizer) | (mg/l) | (h) | (%) | Force (cN) | Tensile Force |
| 1-1 | | — | — | 0 | 0 | 534 | 65 | |
| | | | | 20 | 5 × 1 | 319 | 10 | 15 |
| | | | | 20 | 10 × 1 | 0 | 0 | 0 |
| 1-2* | | — | — | 0 | 0 | 465 | 63 | |
| | | | | 20 | 5 × 1 | 359 | 28 | 44 |
| | | | | 20 | 10 × 1 | 304 | 13 | 21 |
| 1-3 | Zinc oxide | 3 | — | 0 | 0 | 568 | 63 | |
| | | | | 20 | 5 × 1 | 528 | 27 | 43 |
| | | | | 20 | 10 × 1 | 0 | 0 | 0 |
| 1-4 | Mg₆Al₂(OH)₁₆CO₃. | 3 | 2% stearic acid | 0 | 0 | 549 | 60 | |
| | 5H₂O | | | 20 | 5 × 1 | 561 | 38 | 63 |
| | | | | 20 | 10 × 1 | 504 | 29 | 48 |
| 1-5 | Mg₆Al₂(OH)₁₂CO₃)₃. | 3 | — | 0 | 0 | 597 | 63 | |
| | 5H₂O | | | 20 | 5 × 1 | 554 | 42 | 67 |
| | | | | 20 | 10 × 1 | 564 | 39 | 62 |
| 1-6 | Mg₆Al₂(OH)₁₆CO₃. | 3 | 5% Baysilone | 0 | 0 | 595 | 61 | |
| | 5H₂O | | Oil GPW | 20 | 5 × 1 | 597 | 45 | 74 |
| | | | 2233** | 20 | 10 × 1 | 603 | 42 | 69 |
| 1-7 | Mg₆Al₂(OH)₁₆CO₃. | 3 | 2% | 0 | 0 | 480 | 68 | |
| | 5H₂O | | magnesium | 20 | 5 × 1 | 465 | 55 | 81 |
| | | | stearate | 20 | 10 × 1 | 474 | 54 | 79 |

*Polymer based on polyester
**Manufacturer: GE Bayer Silicones

TABLE 2

| | | Added | Coating with | Spinning Time up to |
|---|---|---|---|---|
| | | Amount of | (wt. % | Thread Break in the |
| | | Stabilizer | with respect to | Spinning Process |
| Sample | Stabilizer | (wt. %) | Stabilizer) | (days) |
| 2-1 | Mg₆Al₂(OH)₁₆CO₃ · 5H₂O | 3 | — | 4 |
| 2-2 | Mg₆A1₂(OH)₁₆CO₃ · 5H₂O | 3 | 5% Baysilone Oil GPW | 6 |
| | | | 2233* | |
| 2-3 | Mg₆Al₂(OH)₁₆CO₃ · 5H₂O | 3 | 2% magnesium stearate | >10 |

*Manufacturer: GE Bayer Silicones

TABLE 3

| | | Added | Coating | Max. | Ad- |
|---|---|---|---|---|---|
| | | Amount of | with (wt. % | Tensile | her- |
| Sam- | | Stabilizer | with respect | Force | ence |
| ple | Stabilizer | (wt. %) | to Stabilizer) | (cN) | (cN) |
| 3-1 | Mg₆Al₂(OH)₁₆CO₃. | 3 | 2% magnesium | 74 | 0.23 |
| | 5H₂O | | stearate | | |
| 3-2 | Mg₆Al₂(OH)₁₆CO₃. | 3 | 5% Baysilone | 74 | 0.44 |
| | 5H₂O | | Oil GPW | | |
| | | | 2233* | | |

*Manufacturer: GE Bayer Silicones

1. Polyurethane urea fibers comprised of at least 85% segmented polyurethane urea, wherein the polyurethane urea fibers contain 0.05 to 10 wt. % of hydrotalcite of the formula (1),
M₁₋ₓ²⁺Alₓ(OH)₂A′ₓ/nⁿ⁻.mH₂O (1),
wherein
M²⁺ denotes magnesium,
A′ⁿ⁻ denotes an anion having the valency n and selected from the group consisting of OH⁻, F⁻, Cl⁻, Br⁻, CO₃²⁻, SO₄²⁻, HPO₄²⁻, silicate, acetate and oxalate,
0<x≦0.5 and
0≦m<1
or hydrotalcite of the formula (2)
Mg_{1-y}Al_{y}(OH)ᵤ(A²⁻)_{y/2}.wH₂O (2)
wherein 0.20<y<0.35, u is a number from 1 to 10, w is a number from 0 to 20 and A²⁻ is an anion selected from the group consisting of CO₃²⁻, SO₄²⁻ or HPO₄²⁻,
wherein the hydrotalcites are coated with 0.2 to 15 wt. % of a metal fatty acid salt.

2. Polyurethane urea fibers according to claim 1, wherein said amount of hydrotalcite is 0.5 wt. % to 8 wt. %, based on the weight of the fibers.

3. Polyurethane urea fibers according to claim 2, wherein said amount of hydrotalcite is from 1.5 wt % to 7 wt. %, based on the weight of the fibers.

4. Polyurethane urea fibers according to claim 3, wherein said amount of hydrotalcite is from 2 wt. % to 5 wt. %, based on the weight of the fibers.

5. Polyurethane urea fibers according to claim 1 or 2, wherein said hydrotalcite is a hydrotalcite of the formulae (3) or (4):
Mg₆Al₂(OH)₁₆(A²⁻).wH₂O (3);
Mg₄Al₂(OH)₁₂(A²⁻).wH₂O (4),
in which A²⁻ and w have the meanings given above in formula (2).

6. Polyurethane urea fibers according to claim 5, wherein said hydrotalcite is a hydrotalcite of the formulae (5) or (6):
Mg₆Al₂(OH)₁₆CO₃.5H₂O (5);
Mg₄Al₂(OH)₁₂CO₃.4H₂O (6).

7. Polyurethane urea fibers according to claim 1 or 2, wherein said hydrotalcite is coated with said metal fatty acid salt in an amount of from 0.2 to 15 wt. %, based on the weight of the hydrotalcite.

8. Polyurethane urea fibers according to claim 7, wherein said amount is from 0.3 to 12 wt. %, based on the weight of the hydrotalcite.

9. Polyurethane urea fibers according to claim 8, wherein said amount is from 0.5 to 8 wt. %, based on the weight of the hydrotalcite.

10. Polyurethane urea fibers according to claim 1 or 2, wherein said metal fatty acid salt is a metal fatty acid salt of a metal selected from main groups I to III of the Periodic System, or zinc, the fatty acid is a saturated or unsaturated fatty acid that contains at least 6 to at most 30 carbon atoms and said metal fatty acid salt is monofunctional or bifunctional.

11. Polyurethane urea fibers according to claim 10, wherein said metal fatty acid salt is selected from the group consisting of: lithium, magnesium, calcium, aluminum and zinc salts of oleic, palmitic or stearic acid.

12. Polyurethane urea fibers according to claim 11, wherein said metal fatty acid salt is magnesium stearate, calcium stearate or aluminum stearate.

13. Polyurethane urea fibers according to claim 12, wherein said metal fatty acid salt is magnesium stearate.

14. Polyurethane urea fibers according to claim 1 or 2, wherein the hydrotalcite coated with metal fatty acid salt has a mean diameter (numerical mean) of at most 5 μm.

15. Polyurethane fibers according to claim 14, wherein said mean diameter is at most 3 μm.

16. Polyurethane fibers according to claim 15, wherein said mean diameter is at most 1 μm.

17. Process for the production of the polyurethane urea fibres of claim 1 or 2, in which a long-chain synthetic polymer containing at least 85% segmented polyurethane is dissolved in an organic solvent, in an amount of 20 to 50 wt. % based on the weight of the polyurethane urea composition, and this solution is then spun through spinnerets by the dry or wet spinning process into filaments, wherein a hydrotalcite coated with a metal fatty acid salt is added in an amount of 0.05 wt. % to 10 wt. %, based on the weight of the polyurethane urea fiber, to the spinning solution and is distributed within the filaments and/or on the filament surface.

18. Process of claim 17, wherein said organic solvent is dimethylacetamide, dimethylformamide or dimethylsulfoxide.

19. Process of claim 17, wherein said amount of solvent is 25 to 45 wt. % based on the weight of the polyurethane urea composition.

20. Process of claim 17, wherein said amount of hydrotalcite coated with a metal fatty acid salt is from 0.5 wt. % to 8 wt. %, based on the weight of the polyurethane urea fiber.

21. Process of claim 20, wherein said amount of hydrotalcite coated with a metal fatty acid salt is from 1.5 wt. % to 7 wt. %, based on the weight of the polyurethane urea fiber.

22. process of claim 21, wherein said amount of hydrotalcite coated with a metal fatty acid salt is from 2 wt, % to 5 wt. %, based on the weight of the polyurethane urea fiber.

23. Knitwear, hosiery or woven goods, comprising the polyurethane urea fibres of claim 1 or 2, optionally mixed with synthetic hard fibers and/or with natural fibers.

24. Knitwear, hosiery or woven goods according to claim 23, wherein said synthetic hard fibers are polyamide, polyester or polyacrylic fibers and said natural fibers are wool, silk or cotton.
